(19) United States
(12) Patent Application Publication
(10) Pub. No.: US 2004/0247844 A1
(43) Pub. Date: Dec. 9, 2004

(54) Ceramic material coating method and ceramic film

(75) Inventors: Takeshi Kijima, Matsumoto-shi (JP); Eiji Natori, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/808,447

(22) Filed: Mar. 25, 2004

(30) Foreign Application Priority Data
Mar. 28, 2003 (JP) 2003-091718

(51) Int. Cl. B32B 3/00

(52) U.S. Cl. 428/210

(57) ABSTRACT

A ceramic material coating method of forming a coating film on a base by applying a ceramic material including a complex oxide to the base by spin coating, the method includes: a first rotational step of rotating the base at a predetermined rotational speed; a second rotational step of rotating the base at a rotational speed lower than the rotational speed in the first rotational step; and a third rotational step of rotating the base at a rotational speed higher than the rotational speed in the second rotational step.

Japanese Patent Application No. 2003-91718, filed on Mar. 28, 2003, is hereby incorporated by reference in its entirety.

### BACKGROUND OF THE INVENTION

The present invention relates to a ceramic material coating method and a ceramic film.

As a ferroelectric film applied to semiconductor devices (ferroelectric memory (FeRAM), for example), a ferroelectric film having a perovskite structure (PbZrTiO, for example) and a ferroelectric film having a layered perovskite structure (BiLaTiO, BiTiO, or SrBiTaO, for example) have been proposed.

As a method of forming such a ferroelectric film, a spin coating method using a sol-gel material or an MOD material has been known. The spin coating method has advantages in that composition of the film is easily controlled and particles are not generated in comparison with a sputtering method.

### BRIEF SUMMARY OF THE INVENTION

The present invention may provide a ceramic material coating method capable of forming a ceramic film having excellent film characteristics and a ceramic film.

One aspect of the present invention relates to a ceramic material coating method of forming a coating film on a base by applying a ceramic material including a complex oxide to the base by spin coating, the method including:

a first rotational step of rotating the base at a predetermined rotational speed;

a second rotational step of rotating the base at a rotational speed lower than the rotational speed in the first rotational step; and

a third rotational step of rotating the base at a rotational speed higher than the rotational speed in the second rotational step.

With this aspect, since the method includes the second rotational step of rotating the base at a rotational speed lower than that of the first rotational step, a ceramic film having excellent film characteristics can be obtained

With this ceramic material coating method, the rotational speed in the third rotational step may be higher than the rotational speed in the first rotational step.

This ceramic material coating method may further include a step of drying the coating film after forming the coating film by the spin coating.

With this ceramic material coating method, the step of drying the coating film may be performed by blowing gas onto the coating film.

With this ceramic material coating method, the ceramic material may include at least one of a sol-gel raw material and an MOD raw material, the sol-get raw material including at least one of a hydrolysate and a polycondensate of the complex oxide, the MOD raw material including constituent elements of the complex oxide in an organic solvent.

With this ceramic material coating method, the base to which the ceramic material is applied may include an electrode layer made of a platinum group element on a surface of the base.

Another aspect of the present invention relates to a ceramic film obtained by any one of the above ceramic material coating methods.

### BRIEF DESCRIPTION OF THE SEVERAL VIEWS OF THE DRAWING

FIG. 1 schematically shows a coating method according to an embodiment of the present invention.

FIG. 2 schematically shows a conventional coating method.

FIGS. 3A and 3B show hysteresis characteristics of specimen PZT films in an example of this embodiment of the present invention, and FIG. 3C shows hysteresis characteristics of a specimen PZT film in a comparative example.

### DETAILED DESCRIPTION OF THE EMBODIMENT

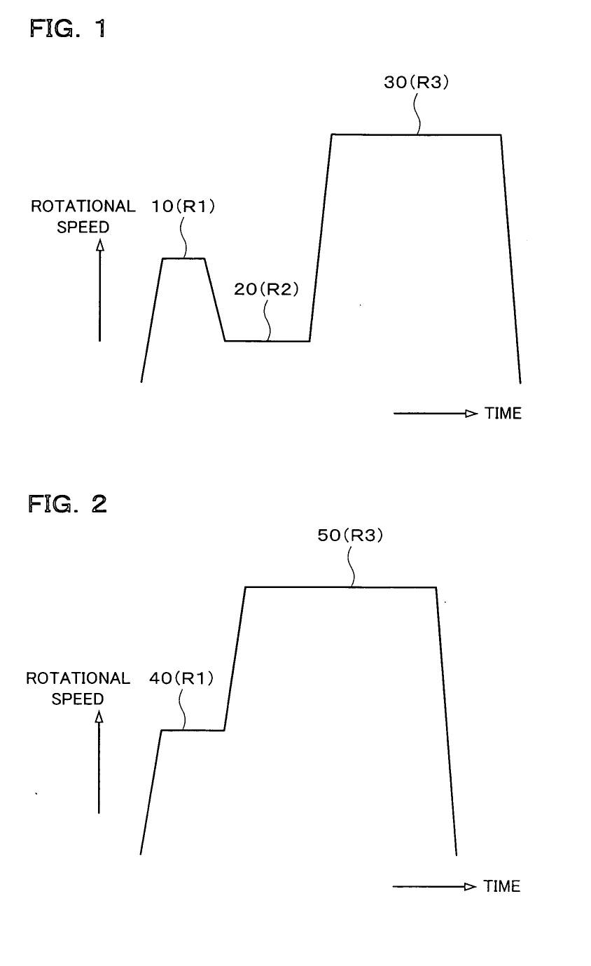

An example of an embodiment according to the present invention is described below. FIG. 1 schematically shows a spin coating rotational speed in a coating method of the present embodiment.

In the ceramic material coating method according to the present embodiment, a ceramic material including a complex oxide is applied to a base by spin coating to form a coating film. The coating method includes a first rotational step of rotating the base at a predetermined rotational speed, a second rotational step of rotating the base at a rotational speed lower than the rotational speed in the first rotational step, and a third rotational step of rotating the base at a rotational speed higher than the rotational speed in the second rotational step.

In more detail, when the ceramic material is applied on the base by spin coating, the base is rotated at a first rotational speed (R1) in a first rotational step 10, as shown in FIG. 1. In a second rotational step 20, the base is rotated at a rotational speed (R2) lower than the rotational speed in the first rotational step 10. In a third rotational step 30, the base is rotated at a rotational speed (R3) higher than the rotational speed in the second rotational step 20.

The first rotational step 10 is a step for spreading the ceramic material over the entire surface of the base. The third rotational step 30 is a step for uniformly distributing the ceramic material on the base. The present embodiment is characterized by including the second rotational step 20, in which the base is rotated at a rotational speed (R2) lower than the rotational speed in the first rotational step 10, after the first rotational step 10. A ceramic film having excellent film characteristics can be obtained by performing the second rotational step 20.

The reason why an excellent ceramic film can be obtained by this coating method is not necessarily known. For example, the following reason may be considered. Specifically, the period of time in which the ceramic material remains on the base is increased by performing the second rotational step 20 in which the base is rotated at a lower speed or stopped before the third rotational step 30 in which the base is rotated at a higher speed. Therefore, the period of time in which the ceramic material comes in contact with an electrode such as an electrode made of a platinum group element increases, whereby a good effect can be exerted on the resulting crystal structure. As examples of the platinum group elements, platinum, ruthenium, rhodium, palladium, osmium, and iridium can be given. These elements have catalytic effects and contribute to an alcohol exchange reaction of a sol-gel raw material, for example, thereby exerting a good effect on characteristics of the resulting ceramic film.

In a conventional method, a second rotational step 50 in which the base is rotated at a rotational speed (R3) is performed after a first rotational step 40 in which the base is rotated at a rotational speed (R1), as shown in FIG. 2. The first rotational step 40 shown in FIG. 2 is performed for the same objective as that of the first rotational step 10 in the present embodiment. The second rotational step 50 is performed for the same objective as that of the third rotational step 30 in the present embodiment. In the present embodiment, the characteristics of the resulting ceramic film are significantly improved by performing the second rotational step 20 in which the base is rotated at a lower speed, as described later in an example.

In the coating method of the present embodiment, the rotational speed (R3) of the base in the third rotational step 30 is preferably higher than the rotational speed (R1) of the base in the first rotational step 10. A coating film with a uniform thickness can be formed by setting such a rotational speed. In order to form a coating film with a uniform thickness, the rotational time of the base in the third rotational step 30 is preferably longer than the rotational time of the base in the first rotational step 10.

FIG. 1 illustrates an example in which the base is rotated at a constant speed for a predetermined period of time in each of the first to third rotational steps. In the present embodiment, the base is not necessarily rotated at a constant speed in each rotational step. The rotational speed may be changed in a plurality of stages or continuously. It suffices that the coating method of the present embodiment include the first to third rotational steps. The coating method may further include other rotational steps.

The coating method of the present embodiment may further include a first heat treatment step of drying the coating film after forming the coating film on the base by spin coating. The first heat treatment step of drying the coating film may be performed by using a blow treatment in which a gas such as an inert gas (nitrogen gas, for example) is blown onto the coating film. The gas used for the blow treatment may be heated to about 100° C. In the case where Pb is included in the coating film, Pb easily vaporizes at about 120° C. or more. Therefore, the heating temperature is set at about 100° C. The first heat treatment step may be performed by heating the base at about 150° C. by using a hot plate, for example. A second heat treatment may be performed in which the coating film is presintered by heating the base on a hot plate. The second heat treatment may be performed at a temperature higher than the temperature of the first heat treatment (about 300° C., for example).

In the coating method of the present embodiment, the ceramic material may include at least one of a sol-gel raw material which includes at least either a hydrolysate or a polycondensate of a complex oxide and an MOD raw material which includes constituent elements of the complex oxide in an organic solvent.

The sol-gel raw material may be prepared as described below. Metal alkoxides having four or less carbon atoms are mixed and subjected to hydrolysis and polycondensation. A strong M—O—M—O . . . bond is formed by hydrolysis and polycondensation. The resulting M—O—M bond has a structure similar to the ceramic crystal structure (perovskite structure). M represents a metal element (Bi, Ti, La, or Pb, for example), and O represents oxygen. A solvent is added to the product obtained by hydrolysis and polycondensation to obtain a raw material. The sol-gel raw material is prepared in this manner.

As examples of the MOD raw material, a polynuclear metal complex raw material in which constituent elements of the ceramic film are continuously connected either directly or indirectly can be given. As specific examples of the MOD raw material, a metal salt of a carboxylic acid can be given. As examples of the carboxylic acid, acetic acid, 2-ethylhexanoic acid, and the like can be given. As examples of the metal, Bi, Ti, La, Pb, and the like can be given. The MOD raw material has an M—O bond in the same manner as the sol-gel raw material. However, the M—O bond does not form a continuous bond as in the sol-gel raw material obtained by polycondensation. Moreover, the bond structure is similar to the linear structure and completely differs from the perovskite structure.

In the ceramic material, the sol-gel raw material or the MOD raw material may be adjusted to the stoichiometric composition of the complex oxide, and the mixture of the raw materials may include the metal material (Pb or Bi, for example) included in the complex oxide in excess of the stoichiometric composition.

In the present embodiment, the ceramic material may include a paraelectric material having a catalytic effect on the complex oxide in addition to the complex oxide. If the paraelectric material is present in the ceramic material in a mixed state in addition to the complex oxide which makes up the ferroelectric, a part of the constituent elements of the complex oxide is replaced by the constituent element of the paraelectric material during the crystallization process of the complex oxide, whereby the crystallization temperature can be reduced.

The paraelectric material may include an oxide which includes Si or Ge in the constituent elements or an oxide which includes Si and Ge in the constituent elements.

As the paraelectric material, an oxide which includes Si or Ge in the constituent elements or an oxide which includes Si and Ge in the constituent elements may be used, for example. As such an oxide, a paraelectric material shown by ABO_{X} or BO_{X}, in which the A site includes a single element or a composite element of Pb, Bi, Hf, Zr, V, or W and the B site includes a single element or a composite element of Si or Ge, may be used. Specific examples include PbSiO (Pb₅Si₃O_{X} or Pb₂Si₁O_{X}), PbGeO (Pb₅Ge₃O_{X} or Pb₂Ge₁O_{X}), BiSiO (Bi₄Si₃O_{X} or Bi₂Si₁O_{X}), BiGeO (Bi₄Ge₃O_{X} or Bi₂Si₁O_{X}), ZrGeO_{X}, HfGeO_{X}, VGeO_{X}, WGeO_{X}, VSiO_{X}, WSiO_{X}, and the like. In the case of using Zr, Hf, V, or W in the A site, occurrence of oxygen vacancy in the ferroelectric is prevented.

As the base, a base in which an electrode layer is formed on a base may be used. As examples of the base, a semiconductor substrate made of a single element semiconductor such as silicon or germanium, a compound semiconductor such as GaAs or ZnSe, or the like, a metal base made of Pt or the like, a sapphire base, and an insulating base made of MgO, SrTiO₃, BaTiO₃, or glass can be given. The base is selected depending on the application of the ceramic film. In the case where the ceramic film is applied to a semiconductor device, a silicon base, and preferably a silicon single crystal base is used as the base.

A ceramic film such as a ferroelectric film can be obtained by subjecting the ceramic material according to the present embodiment to a heat treatment using a conventional method. A ceramic film is obtained as follows, for example. The ceramic material according to the present embodiment is applied to a base by spin coating to form a coating film. The coating film is dried and presintered, if necessary. The coating film is then crystallized by subjecting the coating film to a heat treatment to form a ceramic film.

A further detailed example of the coating method according to the present embodiment is described below with reference to the drawings.

### EXAMPLE

In this example, a PbZr_{0.2}Ti_{0.8}O₃ (PZT) film was formed on a base on which a platinum electrode was formed by using a pressure heat treatment device.

A coating film was formed by using a sol-gel solution for forming a PbZr_{0.2}Ti_{0.8}O₃ film (concentration: 10 wt %) adjusted to the stoichiometric composition. In this example, the amount of excess Pb in the raw material was set at 10 mol %. The coating film was formed by the following steps. The sol-gel solution for forming a PbZr_{0.2}Ti_{0.8}O₃ film was applied to the electrode by spin coating. The spin coating was performed at 500 rpm for three seconds (first rotational step), at 50 rpm for 10 seconds (second rotational step), and at 3000 rpm for 30 seconds (third rotational step). The coating film was heated at 150° C. for two minutes by using a hot plate (drying step), and presintered by heating at 300° C. for five minutes. A coating layer with a thickness of 150 nm was formed by repeating the coating step and the drying and presintering step three times. A specimen obtained in this example is referred to as a specimen 1.

A coating film was obtained in the same manner as the specimen 1 except that a nitrogen gas blow treatment was added in the drying step of the coating film. This coating film is referred to as a specimen 2.

For comparison, a coating film was obtained in the same manner as the specimen 1 except that the second rotational step was not performed. This coating film is referred to as a comparative specimen 1.

The coating film of each specimen was crystallized by using a pressure heat treatment device. The crystallization conditions were set at a pressure of 9.9 atmospheres, a heat treatment temperature of 550° C., and a treatment time of 10 minutes.

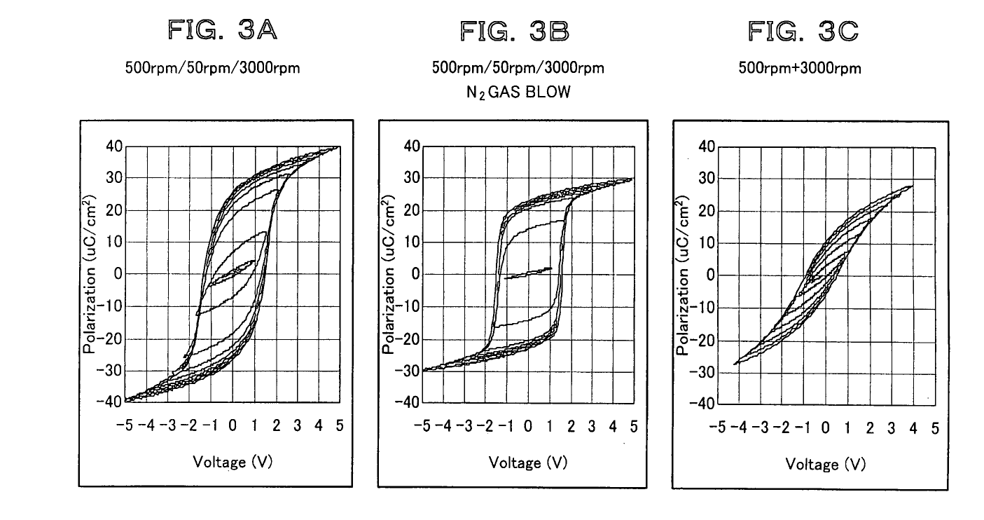

A platinum electrode with a diameter of 100 μm and a thickness of 100 nm was formed on the coating film to obtain a capacitor. Ferroelectric characteristics (hysteresis characteristics) were measured using the resulting capacitor. The results are shown in FIGS. 3A to 3C. FIG. 3A shows the hysteresis characteristics of the specimen 1 according to this example. FIG. 3B shows the hysteresis of the specimen 2 according to this example. FIG. 3C shows the hysteresis characteristics of the comparative specimen 1. As is clear from these results, it was confirmed that the specimens 1 and 2 of this example had a good hysteresis loop with excellent squareness saturated at a low voltage in comparison with the comparative specimen 1. The specimen 2 of this example had further improved hysteresis characteristics in comparison with the specimen 1 of this example by performing the blow treatment in the drying step of the coating film.

As described above, according to the example of the present invention, a ceramic film having excellent ferroelectric characteristics can be formed by performing the first to third rotational steps when the ceramic material is applied by spin coating.

What is claimed is:

1. A ceramic material coating method of forming a coating film on a base by applying a ceramic material including a complex oxide to the base by spin coating, the method comprising:
a first rotational step of rotating the base at a predetermined rotational speed;
a second rotational step of rotating the base at a rotational speed lower than the rotational speed in the first rotational step; and
a third rotational step of rotating the base at a rotational speed higher than the rotational speed in the second rotational step.

2. The ceramic material coating method as defined in claim 1,
wherein the rotational speed in the third rotational step is higher than the rotational speed in the first rotational step.

3. The ceramic material coating method as defined in claim 1, further comprising:
a step of drying the coating film after forming the coating film by the spin coating.

4. The ceramic material coating method as defined in claim 3,
wherein the step of drying the coating film is performed by blowing gas onto the coating film.

5. The ceramic material coating method as defined in claim 1,
wherein the ceramic material includes at least one of a sol-gel raw material and an MOD raw material, the sol-get raw material including at least one of a hydrolysate and a polycondensate of the complex oxide, the MOD raw material including constituent elements of the complex oxide in an organic solvent.

6. The ceramic material coating method as defined in claim 1,
wherein the base to which the ceramic material is applied includes an electrode layer made of a platinum group element on a surface of the base.

7. A ceramic film obtained by the ceramic material coating method as defined by claim 1.

8. A ceramic film obtained by the ceramic material coating method as defined by claim 2.

9. A ceramic film obtained by the ceramic material coating method as defined by claim 3.

10. A ceramic film obtained by the ceramic material coating method as defined by claim 4.
